(19) United States
(12) Patent Application Publication
(10) Pub. No.: US 2006/0008118 A1
(43) Pub. Date: Jan. 12, 2006

(54) Image processing apparatus and image monitoring system

(75) Inventors: Nobuyuki Matsuoka, Tokyo (JP); Kenji Tanaka, Tokyo (JP); Kenichi Shinbou, Tokyo (JP); Tetsuji Haga, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: MITSUBISHI DENKI KABUSHIKI KAISHA, Tokyo (JP)

(21) Appl. No.: 11/106,434

(22) Filed: Apr. 15, 2005

(30) Foreign Application Priority Data
Jul. 2, 2004 (JP) 2004-196859

(51) Int. Cl. G06K 9/00

(52) U.S. Cl. 382/103

(57) ABSTRACT

In a conventional image monitoring system problems have been that images are very unclear and it is sometimes difficult to monitor them, because images to be monitored are displayed intact to a monitoring operator, even if monitoring-unnecessary-moving objects, such as rainfall or snow, are photographed in the monitoring images.

In an image processing apparatus 1, easy-to-monitor images, in which monitoring-unnecessary-moving objects, such as rainfall or snow, have been eliminated, can be displayed to the monitoring operator, because a monitoring-unnecessary-moving-object-eliminating unit 3 processes each of pixel values of consecutive images that have been continuously photographed and stored in image storing units 2, and outputs the images in which the monitoring-unnecessary-moving objects appearing in the consecutive images have been eliminated.

### BACKGROUND OF THE INVENTION

1. Field of the Invention

The present invention relates to an image processing apparatus for generating clear monitoring images by eliminating monitoring-unnecessary-moving objects, such as rainfall or snow, photographed in monitoring images, and to an image monitoring system for monitoring scenes of accidents, crimes and weather in a distant place using the clear monitoring images generated by the image processing apparatus.

2. Description of the Related Art

In a conventional image monitoring system, signals from cameras are distributed to a monitoring center in a distant place apart from the cameras, via public networks such as ISDN or the Internet, or via LAN such as coaxial cables or Ethernet cables (for example, refer to Patent Document 1).

Patent Document 1:

Japanese Laid-Open Open Patent Publications 2000-217169 (FIG. 1)

### SUMMARY OF THE INVENTION

Problems to be solved by the Invention:

Because the conventional image monitoring system is configured as described above, there have been problems in that it is difficult for, for example, a monitoring operator to recognize images, because the images are very unclear, in cases when the monitoring-unnecessary-moving objects, such as rainfall or snow, are photographed in the images in a chosen monitoring site.

The present invention has been made in order to solve above problems, and to provide an image processing apparatus and an image monitoring system using the image processing apparatus for eliminating the monitoring-unnecessary-moving objects such as rainfall or snow photographed in the images by a simple method, so as to provide easy-to-view images to be monitored.

### MEANS FOR SOLVING THE PROBLEMS

An image processing apparatus related to the present invention includes: an image storing unit for storing consecutive images of a chosen monitoring site; and a monitoring-unnecessary-moving-object-eliminating unit for comparing each of corresponding pixel values between the consecutive images and computing new pixel values based on the comparison, and for generating images in which monitoring-unnecessary-moving objects appearing in the consecutive images are eliminated.

The present invention can bring an effect of obtaining images in which the influence due to the monitoring-unnecessary-moving objects has been eliminated from the consecutive images, because the image storing unit in the image processing apparatus records the consecutive images of the chosen monitoring site, and the monitoring-unnecessary-moving-object-eliminating unit computes new pixel values by comparing each of the corresponding pixel values between the above consecutive images, and then generates images in which the monitoring-unnecessary-moving objects appearing in the images have been eliminated.

As an application example of the present invention, the image processing apparatus can be used in preprocessing for a device that detects intruders, etc., by image processing.

### BRIEF DESCRIPTION OF THE DRAWINGS

FIG. 1 is a schematic block diagram of an image processing apparatus according to Embodiment 1 of the invention;

FIG. 2 is a view for explaining variations of pixel values of predetermined pixels in consecutive images;

FIG. 3 is schematic block diagram of an image processing apparatus according to Embodiment 2 of the invention;

FIGS. 4(1)˜4(5) illustrate image difference processes according to Embodiment 2 of the invention;

FIGS. 5(1) and 5(2) represent the results of binary processes for the background difference images illustrated in FIG. 4;

FIG. 6 represents the results of binary-coded images 1 and binary-coded images 2 illustrated in FIG. 5 being AND-processed;

FIG. 7 represents the results of an area-expansion process to the images after the AND process, which are represented in FIG. 6;

FIGS. 8(1)˜8(3) show an example of results of area selection processes; and

FIG. 9 is a schematic structure of an image monitoring system using the image processing apparatus according to Embodiment 3 of the invention.

### DESCRIPTION OF THE SYMBOLS

“1” is an image processing apparatus, “1a” is an image processing apparatus, “2” are image storing units, “3” is a monitoring-unnecessary-moving-object-eliminating unit, “3a” is a monitoring-unnecessary-moving-object-eliminating unit, “4” is a monitoring-unnecessary-moving-object state inputting unit, “31” is an area selecting unit, “32” is an image generating unit, “5” is a monitor, “6” is a camera image transmitting device, “7” is a communication network, “8” is a camera image receiving device, and “9” are cameras.

### DETAILED DESCRIPTION OF THE PREFERRED EMBODIMENTS

### Embodiment 1

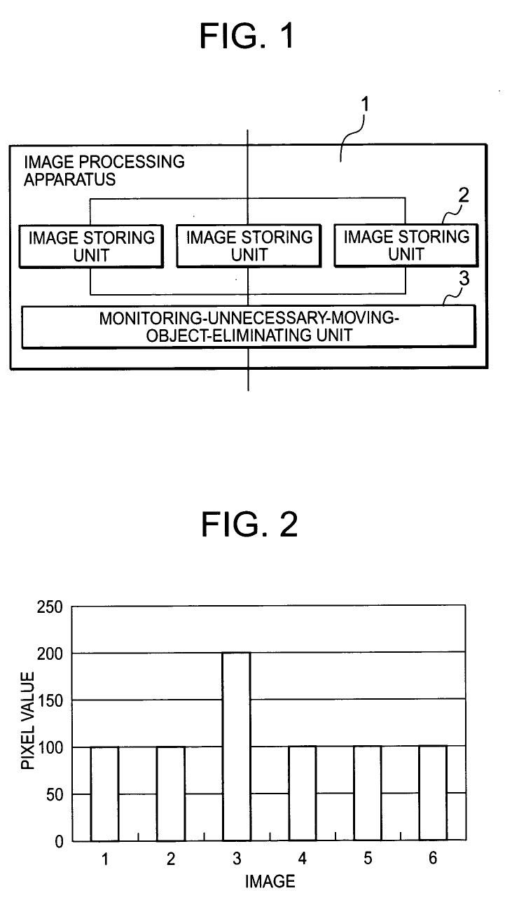

FIG. 1 is a schematic block diagram of an image processing apparatus according to Embodiment 1 of the invention. In FIG. 1, “1” is an image processing apparatus, “2” are image storing units, and “3” is a monitoring-unnecessary-moving-object-eliminating unit. Here, monitoring-unnecessary-moving objects are small moving objects such as rainfall, snow, insects, or dust, which are referred to as moving objects that can be obstacles in recognizing objects to be monitored. In Embodiment 1, the operations of the image processing apparatus 1 will be explained, in which the apparatus can compute new pixel values in accordance with temporal variations of the pixel values on a plurality of images arranged time-sequentially and obtain images in which the influence of the monitoring-unnecessary-moving objects has been decreased.

The image processing apparatus 1 comprises: a plurality of image storing units 2 for recording temporarily a plurality of images arranged time-sequentially in which objects to be monitored are photographed; and a monitoring-unnecessary-moving-object-eliminating unit 3 for comparing each of the corresponding pixel values between the consecutive images stored in the plurality of image storing units 2, and for generating images in which the influence of the monitoring-unnecessary-moving objects, such as rainfall or snow, has been decreased. Hereinafter, the plurality of images arranged time-sequentially that are stored in the plurality of image storing units 2, are referred to as consecutive images.

For example, in an image monitoring system using the image processing apparatus 1 described later, if images are photographed by a stationary camera, a background as an unmoving object, monitoring-moving objects such as cars or humans as objects to be monitored, and monitoring-unnecessary-moving objects such as rainfall or snow as objects to be eliminated may be photographed in the images. In addition, the images, which are converted into digital data as objects to be monitored, are configured from pixels that are arranged with vertically “h” pixels and horizontally “w”, and have 256 levels of gray scale, in which the pixel values from “0” through “255” are assigned to each corresponding pixel. In the digital data, “0” represents black (color), “255” white (color), and these values are referred to as pixel values.

The plurality of image storing units 2 inputs images periodically from devices, such as cameras for obtaining the images, and stores the plurality of consecutive images, one by one. In addition, the definition of the consecutive images used in this process is varied to adjacent images, images picked out from every two images and the like, in accordance with situations.

The monitoring-unnecessary-moving-object-eliminating unit 3 refers to temporal variations of the pixel values of the consecutive images stored in the plurality of image storing units 2. In the images, the monitoring-unnecessary-moving objects, such as rainfall or snow, have whiter colors than colors of the background or the moving objects. In other words, in most cases, the pixel values of the monitoring-unnecessary-moving objects are greater than the pixel values of the background or the moving objects. Therefore, the influence of the monitoring-unnecessary-moving objects can be decreased from the images by computing, by means of a time filter, the pixel values that represent the monitoring-unnecessary-moving objects included in the consecutive images.

FIG. 2 is a view for explaining variations of pixel values of predetermined pixels in consecutive images, and illustrates variations of the pixel values of the predetermined pixels in the consecutive images. Here, it is assumed that a pixel value of “200” indicates the state in which the monitoring-unnecessary-moving objects, such as rainfall or snow, are photographed in the images, and a pixel value of “100” indicates the state in which the monitoring-moving objects to be monitored, such as a background, cars or humans, except for the monitoring-unnecessary-moving objects, are photographed in the images.

In this case, using the pixel value that is closest to the average value of the pixel values (in FIG. 2, the average value is about “122”, and the value closest to the average value is “100”), a pixel value can be obtained, in which objects except for the monitoring-unnecessary-moving objects are photographed in this pixel. The process in which a new pixel value is computed based on the pixel values of the consecutive images as described above, is referred to as a time filter. Applying the time filter to each of the pixel values, the influence of the monitoring-unnecessary-moving objects can be decreased from the images.

As an example of the above time filter, given that the pixel values of the consecutive images are In(x, y), “n” (“n”=1, . . . ,i) is the number for the consecutive images, and “i” is the count of the consecutive images (for example, six images), pixel values “O(x, y)” that are computed by the time filter, are represented by the following formula.
O(x, y)=Im(x, y)
Here, “m” is a value that meets the following formula:
|Im(x, y)−Ave(In(x, y))|=min |In(x, y)−Ave(In(x, y))|, wherein

$$Ave ( In ( x , y ) ) = \frac{1}{i} {\sum }_{n = 1}^{i} In ( x , y ) ;$$

and min |In(x, y)−Ave(In(x, y))| is the minimum value of the differences between the pixel values and the average values.
This time filter is referred to as, a time-average-value filter.

This time-average-value filter, as understood from the above formulas, computes average pixel values of the consecutive images related to the predetermined pixels, so as to compute the minimum value of the differences between the pixel values and the average values. Therefore, the following can be concluded.

(1) When a rate at which the monitoring-unnecessary-moving objects are photographed in the images, is low in cases such as light rainfall or snow, the pixel value that is closest to the average values of the predetermined pixel values, will probably become the pixel value representing the background or the moving object.

(2) When a rate at which the monitoring-unnecessary-moving objects are photographed in the images, is high in cases such as heavy rainfall or snow, the pixel value that is closest to the average values of the predetermined pixel values, will probably become the pixel value representing the monitoring-unnecessary-moving objects.

Therefore, this time-average-value filter is likely to be effective when the rate at which the monitoring-unnecessary-moving objects are photographed in the images, is low.

Moreover, the time filter may compute the minimum value of the predetermined pixel values in the consecutive images. A filter that computes the minimum value of the predetermined pixel values in the consecutive images is referred to as a time-minimum-value filter.

The pixel values “O(x, y)”, after having been filtered by the time-minimum-value filter, are represented as the following formula:
O(x, y)=min(In(x, y)) (n=1, . . . ,i), wherein
min(In(x, y)) is the minimum value of I1(x, y) through Ii(x, y)).

This time-minimum-value filter, as understood from the above formulas, computes the minimum pixel value of the consecutive images related to the predetermined pixels. Therefore, the following can be concluded.

(1) When a rate at which the monitoring-unnecessary-moving objects are photographed in the images, is low in cases such as light rainfall or snow, the minimum value of the predetermined pixel values will probably become the pixel value representing the moving object. However usually, because the pixel values of the consecutive images have been varied when the same objects are photographed, and the minimum value of the variable pixel values is selected in accordance with repeating variations of tones of the images, the total images will probably become dark (images).

(2) When a rate at which the monitoring-unnecessary-moving objects are photographed in the consecutive images, is high in cases such as heavy rainfall or snow. In this case, if there is a possibility that the total images become dark (images), it is preferable that the minimum value of the pixel values are computed, in which there is a highest possibility that the value indicates the background or the monitoring-moving object.

Therefore, this time-minimum-value filter is likely to be effective when the rate at which the monitoring-unnecessary-moving objects are photographed in the images, is high.

That is, if a time-average-value filter is used, in which the filter generates images by comparing each of the pixel values of the consecutive images with the average value of all of the pixel values and computing for each of the pixels a value that is closest to the average value, it is possible to obtain the images that do not become dark, and the images from which the monitoring-unnecessary-moving objects are appropriately eliminated, because the appropriate pixel values can be computed, in which, even if the pixel values increase or decrease by the variation of the images, influence thereof can be prevented. Moreover, if a time-minimum-value filter is used, in which the filter generates images by comparing each of the corresponding pixel values between the consecutive images and computing for each of the pixels a minimum pixel value, the images from which the monitoring-unnecessary-moving objects have been appropriately eliminated, can be obtained even if the rate of the monitoring-unnecessary-moving objects is high, because the rate at which the pixel values except for the monitoring-unnecessary-moving objects can be computed, is high.

### Embodiment 2

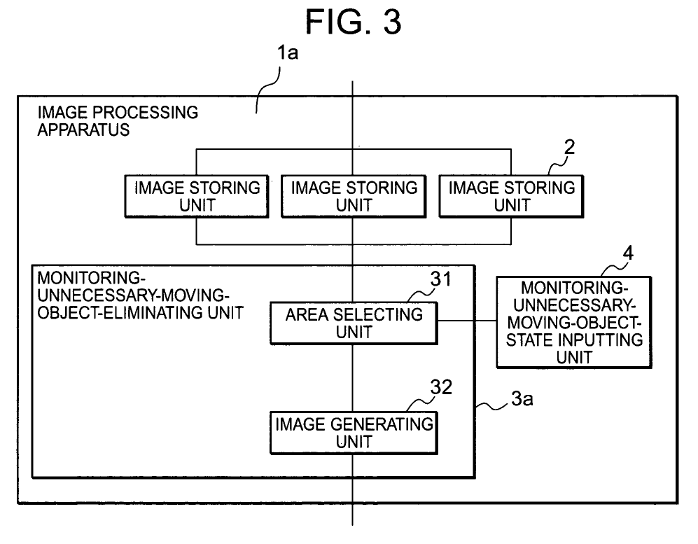

FIG. 3 is a schematic block diagram of an image processing apparatus according to Embodiment 2 of the invention, and because the same symbols as those in FIG. 1 indicate the same or equivalent functions, their explanations are omitted. In FIG. 3, “1a” is an image processing apparatus, “3a” is a monitoring-unnecessary-moving-object-eliminating unit, “31” is an area selecting unit, “32” is an image generating unit, and “4” is a monitoring-unnecessary-moving-object state inputting unit.

In Embodiment 1, the monitoring-unnecessary-moving objects, such as rainfall or snow, are eliminated using either the time-average-value filter or the time-minimum-value filter, to all pixels in an image. Therefore, for example, when the color of monitoring-moving objects to be monitored, such as cars or humans photographed in the images, is white, and the pixel values of the objects are higher than the pixel values of the monitoring-unnecessary-moving objects, such as rainfall or snow, there is a possibility in that the moving objects may disappear from the screen, because the minimum value indicating rainfall or snow is computed, in case of using the time-minimum-value filter. Moreover, it is preferable that the images of the monitoring-moving objects are directly outputted without using the filter.

Therefore, the following can be performed in the image processing apparatus 1a in Embodiment 2.

(1) A method of generating images will be explained, in which the monitoring-moving objects are left intact, while the monitoring-unnecessary-moving objects are eliminated by selecting monitoring-moving-object areas and background areas to be monitored in the images, so that a predetermined appropriate process is performed to each of the areas.

(2) Moreover, a method will be explained, in which a monitoring operator inputs to a monitoring-unnecessary-moving-object-eliminating unit 3a a state of the monitoring-unnecessary-moving objects, such as rainfall or snow, through a monitoring-unnecessary-moving-object state inputting unit 4, so that the monitoring-unnecessary-moving-object-eliminating unit 3a changes monitoring-unnecessary-moving-object-eliminating operations in accordance with the inputted state of the monitoring-unnecessary-moving objects.

The image processing apparatus 1a illustrated in FIG. 3 comprises: a plurality of image storing units 2 that can store a background image and at least two consecutive images inputted from a camera; the area pick out unit 31 for separating the background image and at least two consecutive images into areas of the background image and the monitoring-moving objects; the image generating unit 32 for generating and outputting images in which the influence of the monitoring-unnecessary-moving objects, such as rainfall or snow, has been eliminated by assigning to each of the picked out image areas the pixel values computed by a predetermined method; and the monitoring-unnecessary-moving-object state inputting unit 4 for outputting to the area pick out unit 31 the judgment result in which the monitoring operator has judged the state of the monitoring-unnecessary-moving objects in the images.

The monitoring-unnecessary-moving-object state inputting unit 4 is a man-machine interface for outputting to the area pick out unit 31 the volume of the objects in which the monitoring operator has judged from images the state of the monitoring-unnecessary-moving objects, such as rainfall or snow. In Embodiment 2, the volume can be specified by two levels (strength, in a case of rainfall or snow) of monitoring-unnecessary-moving object volume. The contents of the process are varied based on this specification. The variation of the process contents will be described later.

The plurality of image storing units 2 preliminarily stores one image, in which only a background is photographed and then inputted from a camera, as a background image, and a plurality of consecutive images to be used in the process. In the consecutive images in Embodiment 2, not only the monitoring-moving objects appear overlapped on the plurality of consecutive images but also the monitoring-unnecessary-moving objects are photographed at as short intervals as the objects are not overlapped on the plurality of images.

Moreover, as an example of the area selecting unit 31, a case is described in which the monitoring-unnecessary-moving objects are eliminated from an image by combining a plurality of image processes, and monitoring-moving-object areas, background areas, and boundary areas are selected. In this case, the area selecting unit 31 selects each of the areas using a background difference process, binary-coding process, AND process, and area-expansion process.

Firstly, the area selecting unit 31 subtracts each of the corresponding pixel values between the background image and at least two consecutive images that have been stored in the plurality of image storing units 2. In other words, given that each of the pixel values of the background image is “B(x, y)”, the pixel values of the consecutive images are In(x, y), “n” (“n”=1, . . . ,i) is the number of the consecutive images, and “i” is the count of the consecutive images used for the process, each of the pixel values “Dn(x, y)” of the difference images is computed by the following formula.
Dn(x, y)=In(x, y)−B(x, y)

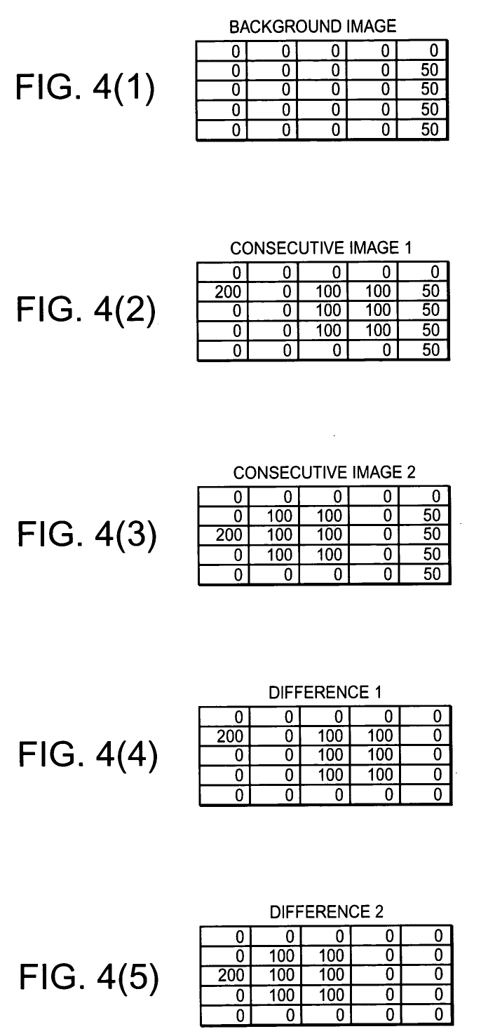

FIGS. 4(1)˜4(5) illustarate the image difference process according to Embodiment 2 of the invention. In this case, an example is described, in which the difference process is executed between a background image and two consecutive images, where the images used in this example consist of pixels with five counts in both the vertical and horizontal orientation. FIG. 4(1) indicates a background image, FIG. 4(2) indicates a first image in the consecutive images (hereinafter, referred to as a consecutive image 1), FIG. 4(3) indicates a second image in the consecutive images (hereinafter, referred to as a consecutive image 2), FIG. 4(4) indicates difference values 1 in which the background image is subtracted from the consecutive image 1, and FIG. 4(5) indicates difference values 2 in which the background image is subtracted from the consecutive image 2.

Moreover, it is assumed that a pixel value of “50” indicates, for example, a background such as trees, a pixel value of “100” indicates big monitoring-moving objects such as cars or humans, and a pixel value of “200” indicates small monitoring-unnecessary-moving objects such as rainfall or snow. Furthermore, as seen from FIGS. 4(4) and 4(5), if the background image is subtracted from the consecutive image 1 or the consecutive image 2, the pixel values of the background areas can be made “0”.

Next, the area selecting unit 31 has determined in advance a threshold value for each of the pixel values, so that the unit replaces each of the pixel values with a value of “1” when each of the pixel values is greater than the threshold value, or with a value of “0” when each of the pixel values is smaller than the threshold value. That is, given that the pixel values after binary-coding process are Tn(x, y), and the threshold value is “t”, the following formula is obtained.

Tn(x, y)=1, when Dn(x, y) is greater than or equal to “t”, or Tn(x, y)=0, when Dn(x, y) is smaller than “t”. The threshold value “t” must be determined at an appropriate value by which moving objects can be detected.

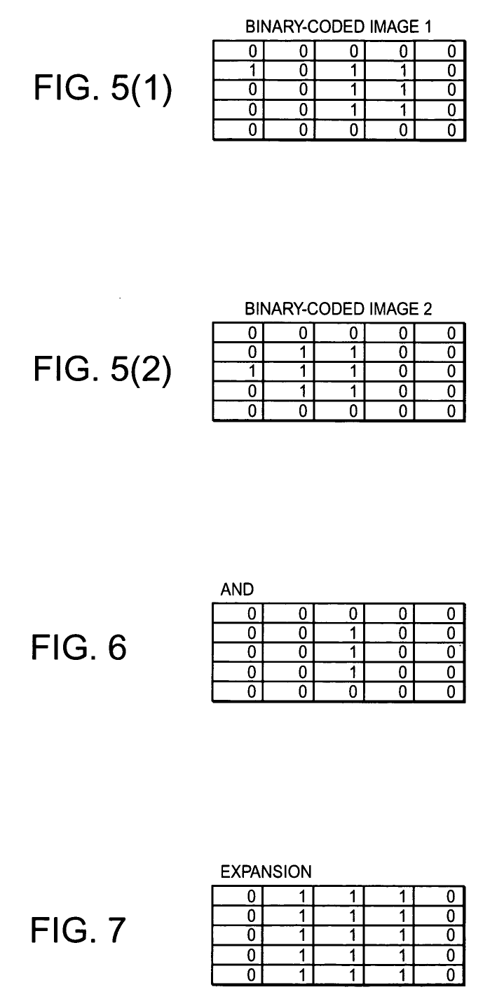

FIGS. 5(1) and 5(2) represent the results of the binary-coding process to the background difference images represented in FIGS. 4(1)˜4(5); and the threshold value is determined at a value of “50” in this case. That is, values in FIG. 5 (1) are binary-coded images (hereinafter, referred to as binary-coded images 1) of values in FIG. 4 (4), and values in FIG. 5 (2) are binary-coded images (hereinafter, referred to as binary-coded images 2) of values in FIG. 4 (5). Owing to this process, the pixel values of only the areas indicating the monitoring-moving objects and/or the monitoring-unnecessary-moving objects are computed to be 1.

Next, the area selecting unit 31 executes an AND calculation for each of the pixel values of a plurality of images obtained by the binary-coding process. That is, given that the pixel values after the AND process are A(x, y), the following formula is obtained.
Tn(x, y)=1: when all of Dn(x, y) are 1 (n=1, . . . ,i); or
Tn(x, y)=0: in the remaining cases

FIG. 6 represents the results of the AND process between the binary-coded images 1 and the binary-coded images 2 represented in FIGS. 5(1) and 5(2). Thereby, small monitoring-unnecessary-moving objects, such as rainfall or snow, are eliminated, and only the pixel values of the areas having big monitoring-moving objects to be monitored, such as cars or humans, are computed to be 1.

In addition, though the areas in which the pixel values are computed to be 1 after the AND process, are considered areas having the monitoring-moving objects in the images, the areas are slightly smaller than actual monitoring-moving-object areas due to the AND process applied to a plurality of binary-coded images. Therefore, the area pick out unit 31 executes an area-expansion process for expanding the areas of the monitoring-moving objects, which have been obtained by the AND process. That is, given that the pixel values after the area-expansion process are E(x, y), the following formula is obtained.
E(x, y)=1: when any of A(x−1, y−1), A(x, y−1), A(x+1, y−1), A(x−1, y1), A(x, y), A(x+1, y), A(x−1, y+1), A(x, y+1), A(x+1, y+1) is 1; or
E(x, y)=0: in the remaining cases

FIG. 7 represents the results of an area-expansion process to the images after the AND process, which are represented in FIG. 6. It is conceivable that the areas expanded by this process become boundary areas between the monitoring-moving objects and the background. The area-expansion process may be repeated more than once.

In accordance with the above processes, the areas in the images may be defined with three areas, which are a monitoring-moving-object area, a background area, and a boundary area.

Each of the areas is determined by the following formulas according to the above processing results.
E(x, y)=0, in the background area
E(x, y)=1, and A(x, y)=0, in the boundary area
A(x, y)=1, in the monitoring-moving-object areas

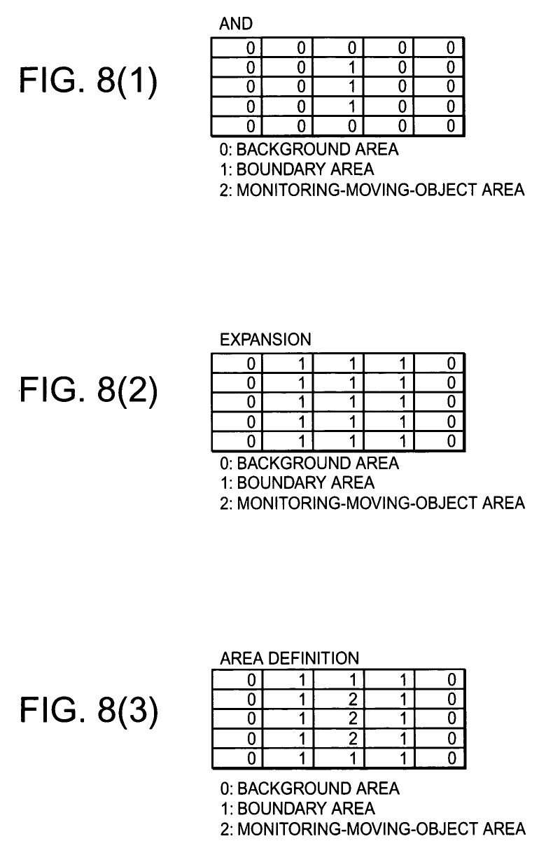

FIGS. 8(1)˜(3) show an example of results of area definition, and FIG. 8(1) indicates the AND process results represented in FIG. 6, FIG. 8(2) indicates the area-expansion results represented in FIG. 7, and FIG. 8(3) indicates the area definition determined from FIGS. 8(1) and 8(2). In FIG. 8(3), an area in which pixel values are “0” is the background area, areas in which pixel values are “1” are the boundary areas, and areas in which pixel values are “0” are the monitoring-moving-object areas.

Thereby, the image generating unit 32 generates images in which the influence by snow or rainfall has been reduced from the original consecutive images, by assigning to each of the above described areas the pixel values according to the following rules. In other words, images can be obtained in which pixels for monitoring-moving objects are left intact, while, by assigning pixel values for each of the areas according to a predetermined calculation method, pixels for monitoring-unnecessary-moving objects in a background are eliminated, so that image visibility can be enhanced. Moreover, the image generating unit 32 changes the process method in accordance with the quantity (in this case, strength indicating a state of rainfall or snow) of the monitoring-unnecessary-moving objects that has been outputted from the monitoring-unnecessary-moving-object state inputting unit 4 by a monitoring operator. Thereby, the operator can change the method into a more suited image generating method in accordance with the state of the monitoring-unnecessary-moving objects.

When the monitoring-unnecessary-moving objects are few (here, in a case of light rainfall or snow), the following can be performed.

(1) The images are processed with consecutive “i” images (for example, six images), and pixel values of the latest image among the consecutive images (hereinafter, referred to as the latest image) are directly assigned to the monitoring-moving-object areas.

(2) The monitoring-unnecessary-moving objects are eliminated using the time-average-value filter in the background areas and boundary areas. In other words, in order to compute the latest state of the monitoring-moving objects without fail, the pixel values of the latest image are directly assigned to the pixel values of the monitoring-moving-object areas even if the monitoring-unnecessary-moving objects are admixed in the images. Moreover, the pixel values in which monitoring-unnecessary-moving objects are eliminated, are assigned to the pixel values in the background areas and the boundary areas, using the time-average-value filter that is suited to a case in which the monitoring-unnecessary-moving objects are few.

When the monitoring-unnecessary-moving objects are many (here, in a case of heavy rainfall or snow), the following can be performed.

(1) The images are processed with the consecutive “i” images (for example, six images), and pixel values of the latest image are directly assigned to the monitoring-moving-object areas.

(2) The monitoring-unnecessary-moving objects are eliminated using the time-average-value filter in the boundary areas.

(3) The monitoring-unnecessary-moving objects are eliminated using the time-minimum-value filter in the background areas.

In other words, in order to compute the latest state of the monitoring-moving objects without fail, the pixel values of the latest image are directly assigned to the pixel values of the monitoring-moving-object areas even if the monitoring-unnecessary-moving objects are admixed in the images. Moreover, in the boundary areas, the monitoring-moving-objects may probably be photographed, and the pixel values computed by the time-average-value filter are assigned to the boundary areas according to the judgment that the closest value to the average value in the consecutive images is the closest value to the monitoring-moving objects, even if the monitoring-unnecessary-moving objects are not eliminated. Moreover, because the background areas are not important areas for monitoring, the pixel values are assigned to the background areas, in which the monitoring-unnecessary-moving objects have been eliminated, using the time-minimum-value filter that is suited to a case in which the monitoring-unnecessary-moving objects are many.

If the above processes are represented by mathematical formulas, the output images O(x, y) are represented by the following formulas. When the monitoring-unnecessary-moving objects are few, the image is represented by the following formulas:
O(x, y)=Ii(x, y), in the monitoring-moving-object areas; and
O(x, y)=Im(x, y), in the boundary areas and the background areas.

Here, “m” is a value that meets the following formula.
|Im(x, y)−Ave(In(x, y))|=min|In(x, y)−Ave(In(x, y))|

And, when the monitoring-unnecessary-moving objects are many, the image is represented by the following formulas:
O(x, y)=Ii(x, y), in the monitoring-moving-object areas;
O(x, y)=Im(x, y), in the boundary areas; and
O(x, y)=min(In(x, y)), in the background areas, where n=1, . . . i.

Here, “m” is a value that meets the following formula:
|Im(x, y)−Ave(In(x, y))|=min|In(x, y)−Ave(In(x, y))|, wherein

$$Ave ( In ( x , y ) ) = \frac{1}{i} {\sum }_{n = 1}^{i} In ( x , y ) ;$$

and min(In(x, y)) is the minimum value of I1(x, y) through Ii(x,y)).

As described above, the images in which the influence by the monitoring-unnecessary-moving objects is decreased, can be obtained without varying visibility of the monitoring-moving objects, by assigning the pixel values of the latest image or the pixel values computed by the time filter, to the pixels of each of the selected image areas. Moreover, the more suitable pixel values can be assigned by selecting the time filter that is used according to states of the monitoring-unnecessary-moving objects, so that the images can be obtained, in which the influence of the monitoring-unnecessary-moving objects is further decreased. In addition, the time filter can eliminate monitoring-unnecessary-moving objects, such as not only rainfall or snow, but also small animals, being insects, or dust raised by strong wind.

### Embodiment 3

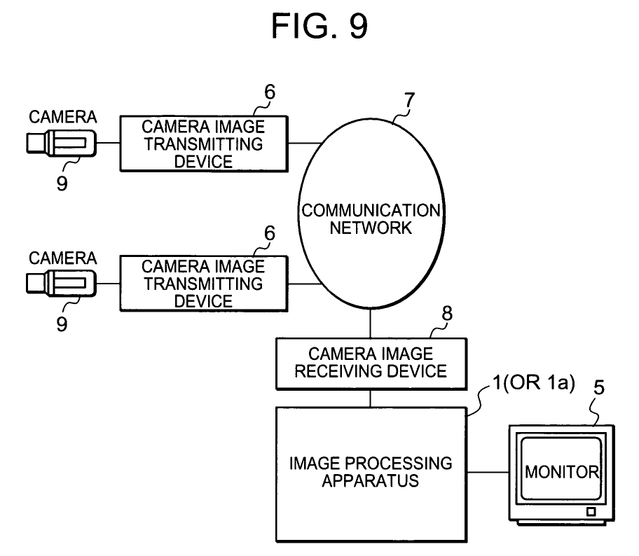

FIG. 9 is a schematic structure of an image monitoring system using an image processing apparatus according to Embodiment 3 of the invention. In FIG. 9, “9” are cameras for inputting images, “6” are camera-image transmitting devices for distributing images, as digital data, from the cameras 9 to a communication network such as the Internet or ISDN, “7” is a communication network such as the Internet, “8” is a camera-image receiving device for receiving the images from the camera-image transmitting device 6, “1” or “1a” is an image processing apparatus for executing a process of reducing influence by monitoring-unnecessary-moving objects from the images received by the camera-image receiving device 8, and “5” is a monitor for outputting the images generated by the image processing apparatus 1 or 1a.

Next, operations will be explained. The camera-image transmitting device 6 receives an image-transmitting request and an image-transmitting-stopping request from the camera-image receiving device 8. When the camera-image transmitting device 6 receives the image-transmitting request from the camera-image receiving device 8, the device 6 converts the digital data of images periodically photographed by the cameras 9 into a data format that can be transmitted to the communication network 7, and then transmits the data to the camera-image receiving device 8 that requires digital data. Moreover, when the camera-image transmitting device 6 receives the image-transmitting-stopping request, the device 6 stops the digital data transmission.

Moreover, the camera-image receiving device 8 transmits the image-transmitting request, to the camera image transmitting device 6 to which a monitoring operator requests to transmit. In other case, the device 8 transmits the image-transmitting-stopping request, to the camera image transmitting device 6 to which the monitoring operator requests to transmit. Moreover, the camera-image receiving device 8 outputs, according to the request, to the image processing apparatus 1 or 1a the digital data transmitted from the camera-image transmitting device 6. The image processing apparatus 1 or 1a is operated in the same way as that in Embodiment 1 or Embodiment 2, and the apparatus 1 or 1a generates the images in which the influence of the monitoring-unnecessary-moving objects are decreased. Moreover, the images generated by the image processing apparatus 1 or 1a are displayed on the monitor 5, the monitoring operator can monitor the object images in high visibility.

By the above configuration, the image monitoring system described in this Embodiment can obtain images in which the influence of the monitoring-unnecessary-moving objects has been reduced, with respect to a plurality of images, to be monitored, that have been transmitted from the cameras 9 installed in remote places.

What is claimed is:

1. An image processing apparatus comprising:
an image storing unit for storing consecutive images of a chosen monitoring site; and
a monitoring-unnecessary-moving-object-eliminating unit for comparing each of corresponding pixel values between the consecutive images and computing new pixel values based on the comparison, and for generating images in which monitoring-unnecessary-moving objects appearing in the consecutive images are eliminated.

2. An image processing apparatus comprising:
an image storing unit for storing a background image representing the background in a chosen monitoring site, and for storing consecutive images of the chosen monitoring site;
an area selecting unit for selecting—
by steps including a first step of computing a difference between the background image and the consecutive images so as to generate at least two difference images, a second step of binarizing, on a predetermined threshold value, the at least two difference images so as to obtain at least two binary difference images, a third step of taking a logical product of the at least two binary difference images so as to generate logical-product images whose pixel values are the logical product—
areas in which the pixel values of the logical product images are one as monitoring-moving-object areas, areas in which the values are expanded as boundary areas, and the remaining areas as background areas; and
a monitoring-unnecessary-moving-object-eliminating unit for generating images in which monitoring-unnecessary-moving objects are eliminated using a method of computing pixel values that are defined for each of the areas selected by the area selecting unit.

3. An image processing apparatus as recited in claim 2, wherein the monitoring-unnecessary-moving-object-eliminating unit obtains state of monitoring-unnecessary-moving objects in the monitoring areas and in accordance with the state generates images using the method of computing pixel values that are defined for each of the areas selected by the area selecting unit.

4. An image processing apparatus as recited in claim 1, wherein the monitoring-unnecessary-moving-object-eliminating unit compares, in consecutive images, each of the pixel values with the average of all the pixel values, and computes the pixel value, for each of the consecutive images, that is closest to the average value and generates respective images therewith.

5. An image processing apparatus as recited in claim 2, wherein the monitoring-unnecessary-moving-object-eliminating unit compares, in consecutive images, each of the pixel values with the average of all the pixel values, and computes the pixel value, for each of the consecutive images, that is closest to the average value and generates respective images therewith.

6. An image processing apparatus as recited in claim 3, wherein the monitoring-unnecessary-moving-object-eliminating unit compares, in consecutive images, each of the pixel values with the average of all the pixel values, and computes the pixel value, for each of the consecutive images, that is closest to the average value and generates respective images therewith.

7. An image processing apparatus as recited in claim 1, wherein the monitoring-unnecessary-moving-object-eliminating unit compares each of pixel values of consecutive images, and computes a minimum pixel value for each of the consecutive images and generates respective images therewith.

8. An image processing apparatus as recited in claim 2, wherein the monitoring-unnecessary-moving-object-eliminating unit compares each of pixel values of consecutive images, and computes a minimum pixel value for each of the consecutive images and generates respective images therewith.

9. An image processing apparatus as recited in claim 3, wherein the monitoring-unnecessary-moving-object-eliminating unit compares each of pixel values of consecutive images, and computes a minimum pixel value for each of the consecutive images and generates respective images therewith.

10. An image monitoring system comprising:
a camera for photographing a chosen monitoring site;
an image transmitting device for transmitting images photographed by the camera;
an image receiving device for receiving the images from the image transmitting device;
an image processing apparatus as recited in claim 1, for eliminating monitoring-unnecessary-moving objects appearing in the images from the image receiving device; and
an outputting device for outputting images from the image processing apparatus.

11. An image monitoring system comprising:
a camera for photographing a chosen monitoring site;
an image transmitting device for transmitting images photographed by the camera;
an image receiving device for receiving the images from the image transmitting device;
an image processing apparatus as recited in claim 2, for eliminating monitoring-unnecessary-moving objects appearing in the images from the image receiving device; and
an outputting device for outputting images from the image processing apparatus.

12. An image monitoring system comprising:
a camera for photographing a chosen monitoring site;
an image transmitting device for transmitting images photographed by the camera;
an image receiving device for receiving the images from the image transmitting device;
an image processing apparatus as recited in claim 3, for eliminating monitoring-unnecessary-moving objects appearing in the images from the image receiving device; and
an outputting device for outputting images from the image processing apparatus.

13. An image monitoring system comprising:
a camera for photographing a chosen monitoring site;
an image transmitting device for transmitting images photographed by the camera;
an image receiving device for receiving the images from the image transmitting device;
an image processing apparatus as recited in claim 4, for eliminating monitoring-unnecessary-moving objects appearing in the images from the image receiving device; and
an outputting device for outputting images from the image processing apparatus.

14. An image monitoring system comprising:
a camera for photographing a chosen monitoring site;
an image transmitting device for transmitting images photographed by the camera;
an image receiving device for receiving the images from the image transmitting device;
an image processing apparatus as recited in claim 5, for eliminating monitoring-unnecessary-moving objects appearing in the images from the image receiving device; and
an outputting device for outputting images from the image processing apparatus.

15. An image monitoring system comprising:
a camera for photographing a chosen monitoring site;
an image transmitting device for transmitting images photographed by the camera;
an image receiving device for receiving the images from the image transmitting device;
an image processing apparatus as recited in claim 6, for eliminating monitoring-unnecessary-moving objects appearing in the images from the image receiving device; and
an outputting device for outputting images from the image processing apparatus.

16. An image monitoring system comprising:
a camera for photographing a chosen monitoring site;
an image transmitting device for transmitting images photographed by the camera;
an image receiving device for receiving the images from the image transmitting device;
an image processing apparatus as recited in claim 7, for eliminating monitoring-unnecessary-moving objects appearing in the images from the image receiving device; and
an outputting device for outputting images from the image processing apparatus.

17. An image monitoring system comprising:
a camera for photographing a chosen monitoring site;
an image transmitting device for transmitting images photographed by the camera;
an image receiving device for receiving the images from the image transmitting device;
an image processing apparatus as recited in claim 8, for eliminating monitoring-unnecessary-moving objects appearing in the images from the image receiving device; and
an outputting device for outputting images from the image processing apparatus.

18. An image monitoring system comprising:
a camera for photographing a chosen monitoring site;
an image transmitting device for transmitting images photographed by the camera;
an image receiving device for receiving the images from the image transmitting device;
an image processing apparatus as recited in claim 9, for eliminating monitoring-unnecessary-moving objects appearing in the images from the image receiving device; and
an outputting device for outputting images from the image processing apparatus.
